(19) United States
(12) Patent Application Publication
(10) Pub. No.: US 2009/0106038 A1
(43) Pub. Date: Apr. 23, 2009

(54) INFORMATION SYSTEM INCLUDING MANAGEMENT SERVER AND SUPPORT SERVER

(75) Inventors: Shinya SAWAKI, Kawasaki (JP); Atsushi Sekiguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/246,776

(22) Filed: Oct. 7, 2008

(30) Foreign Application Priority Data
Oct. 19, 2007 (JP) JP2007-272669

(51) Int. Cl. G06Q 10/00

(52) U.S. Cl. 705/1

(57) ABSTRACT

A support server 31, when notifying a sales management server 23 of identifying information unique to a personal computer 5 together with user identifying information, includes means receiving component identifying information of components included in the personal computer 5 identified by the identifying information unique to the personal computer from the sales management server 23.

### BACKGROUND

The disclose relates generally to an information system, and more particularly to an information system for providing a support service to a customer.

### Background Art

A person, (who will hereinafter be referred to as a user) who purchased an electric appliance, information equipment and other products, utilizes a support service in the case of inquiring about the purchased product. The “support service” is a service for supporting the user if the user does not know a usage of the purchased product and if a trouble occurs. For example, when the user telephones a call center, support staff (operator) provides a useful piece of information so that the user himself or herself can solve an item of the problem.

The user desiring to utilize the support service informs the operator (who will hereinafter called the support staff) at the call center of items of identifying information (which will hereinafter be termed product identifying information) unique to the product such as a product name, a model name and a manufacturing number allocated to each individual product. Note that the “model name” represents a name of type, a model number, a product number, etc allocated to each individual product.

In response to the query of the user, the support staff strives for supporting a solution of the problem on the basis of the information reported from the user. A large number of persons, who request the support service, are users of personal computers, and therefore the following discussion will be focused the personal computer as a product.

The user is required to make support registration in order for the user to receive the support. Then, the support registration entails applying for an identification number unique to the personal computer. Further, the personal computers have the same manufacturing number on a model-name basis in a system where the model name is associated with the manufacturing number, and the model name and the manufacturing number are separately described on a body of the personal computer.

If the user mistakenly registers any one of the O model name and the manufacturing number as the number for receiving the support, however, there is a possibility that plural pieces of the same personal computer information exist among the users. Hence, in this case, a problem is that on the occasion of providing the support, it is difficult for the support staff to specify one single personal computer exactly.

Moreover, nowadays, a spotlight is switched onto a [self-customized] original product (e.g., an original personal computer) constructed of parts (which will hereinafter be referred to as ordered components) of which a combination for the personal computer etc is designated and ordered by the user. This type of self-customized product is called a BTO (Build To Order) product. These products are diversified in their variations in terms of system configurations.
[Patent document 1] Japanese Patent Laid-Open Publication No. 2001-24807
[Patent document 2] Japanese Patent Laid-Open Publication No. 2002-73860
[Patent document 3] Japanese Patent Laid-Open Publication No. H06-152759

### SUMMARY

The product was not, however, hitherto managed in such a way that the ordered components are associated with the model name and the manufacturing number of the product body. Therefore, in the product into which the parts can be assembled, it is difficult to specify information of the ordered component (which will hereinafter be termed parts information) from the model name and the manufacturing number. Hence, there is a limit on providing the proper customer support service of the product owned by the user.

Namely, if inaccurate to grasp the parts information of the product, the time expended for queries and answers between the support staff and the user elongates, with the result that the support service can not be efficiently provided. Further, in recent years, a circulation of secondhand products such as pre-owned personal computers has expanded in scale. As for the pre-owned product, the owner when sold is different from the owner at the present.

Usually, the support service is not provided if not the owner at the selling time. After checking the product unique identifying information given as a requirement for providing the support service, however, it might prove itself that the present owner is different from the owner when sold. In this case, the support service is not eventually provided to the user. In such a case, the user comes to have a feeling that the time was spent wastefully, resulting in a cause of trouble.

The present system was proposed in view of the circumstances described above. Then, it is an object, which is to be accomplished, to enable the support staff to easily grasp the accurate information about the product owned by the user without inquiring the user. It is another object to enable the proper support to be provided, suited to the product owned by the user.

Then, the present system adopts the following means. Namely, an information system comprises a sales management server managing an on-sale configuration of a product including one or more individually sale-enabled components and a support server providing an after-sale service to a user of the product.

The sales management server includes: means accepting an input of component identifying information of the component selected from within a selectable component group for the product when the product is sold; means generating product identifying information for distinguishing between the sold product including the selected component and another sold product; configuration storage means stored with a combination of the product identifying information generated for the product and the component identifying information of the component included in the product; means prompting attachment of the product identifying information to the product to be sold; means acquiring user identifying information of the product together with the product identifying information of the product via the support server; and sales user storage means stored with a combination of the product identifying information and the user identifying information of the product.

The support server includes: means accepting, when providing the user of the product with the service, the user identifying information of the user and the product identifying information of the product becoming a service target product of a service with which the user desires to be provided; user product storage means stored with the user identifying information and the product identifying information; means notifying the sales management server of the product identifying information together with the accepted user identifying information; means receiving, from the sales management server, the component identifying information of the component included in the product identified by the product identifying information; and means displaying the received component identifying information.

Herein, the “service” connotes, e.g., providing a useful piece of information to a user via the support server in order to solve an item of problem about a product. The “product identifying information” represents identifying information unique to the product. The identifying information unique to the product is generated by a sales management server and attached to the product at a manufacturing place when manufacturing the product. The support server allocates the user identifying information, i.e., a so-called user ID.

In this system, the support server, when notifying the sales management server of the identifying information unique to the product together with the user identifying information, can receive the component identifying information of the component included in the product identified by the identifying information unique to the product from the sales management server.

The component identifying information and the product identifying information defined as the identifying information unique to the product are paired and thus stored in the configuration storage means of the sales management server. Accordingly, when the sales management server accepts the product identifying information, at least the component identifying information and the product information can be extracted based on the product identifying information.

Therefore, the support server facilitates specifying the components building up the product and one or more individually sale-enabled components from the identifying information unique to the product with respect to the product owned by the customer when the customer makes a request for the support by use of a user terminal. Hence, there is no necessity for inquiring the customer each time about the specifying information related to the components building up the product owned by the customer and one or more individually sale-enabled components.

In the present system, the in-depth information about the product owned by the user is easily grasped, and therefore the precise and proper support service suited to the product owned by the customer can be provided.

### BRIEF DESCRIPTION OF THE DRAWINGS

FIG. 1 is a view showing an entire information system according to the present invention.

FIG. 2 is a view illustrating a content of data stored in an IC tag when delivering a personal computer.

FIG. 3 is a view illustrating a content of data stored in the IC tag when sold.

FIG. 4 is a view illustrating a content of data stored in the IC tag when a fault occurs.

FIG. 5 is a flowchart showing a course of how a support service is provided to a user in the present information system.

FIG. 6 is a flowchart continued from FIG. 5.

FIG. 7 is an explanatory flowchart showing subsequent processes in the case of receiving an order of the personal computer at a web market or a sales shop.

FIG. 8 is a flowchart showing an example of queries and answers between the user and an operator.

FIG. 9 is a flowchart showing another example of the queries and the answers between the user and the operator.

FIG. 10 is an explanatory view showing contents of a user registration DB and of a sales management DB according to the present system.

### DETAILED DESCRIPTION

A best mode (which will hereinafter be termed an embodiment) for carrying out the present system will hereinafter be described based on working examples. A configuration in the embodiment is, however, an exemplification, and it is not a purport that the scope of the present system is limited to the exemplification. Accordingly, the present system can be, as a matter of course, changed in a variety of forms within the scope that does not deviate from the gist of the present system.

### <Outline of System>

The system may not inquire a user each time about information on a product possessed by the user who requests a call center for a support service. Key information is inputted to the system, thereby enabling the system to extract in-depth fabricating information.

(1) Allocation of Product Unique Identifying Information from Sales Management Server

The system stores, when selling the product, a database (which will hereinafter be abbreviated to DB) with product unique identifying information for uniquely identifying the already-sold product and pieces of identifying information of individual components from which to fabricate the product in a way that associates these items of information with each other. The product will hereinafter be exemplified by a personal computer, and hence the product unique identifying information is referred to as PC unique identifying information. The product is not, however, limited to the personal computer.

(2) Associative Relation between Occurrence of PC Unique Identifying Information and Components

An order of the personal computer is received, for example, at a sales shop, at a website on the Internet and by telephone. The user designates a combination of the components building up the product on an order-by-order basis. The order containing the combination of the designated components is inputted from on a computer at the shop, via a web server providing the website and from on a computer of the recipient on the phone, and is transferred to a sales management server provided on the network. The sales management server, when receiving the order, generates the PC unique identifying information and stores this information in a sales management database (which will hereinafter be simply referred to as the sales management DB) defined as the database thereof. The PC unique identifying information is transferred to a factory together with component identifying information (which will be described later on) of the components included in the personal computer.

(3) At the manufacturing factory, the personal computer is assembled and attached with a label of the PC unique identifying information. Further, the PC unique identifying information may also be inputted to an IC tag, and this IC tag may be attached to the PC.

(4) Sales and Handover

When the personal computer is handed over at the shop, the PC unique identifying information is inputted to the computer and notified to the sales management server. The sale of the PC is confirmed from this notification. The sales management server stores the PC unique identifying information and the component identifying information in the sales management DB.

Moreover, at the shop, the components may be inspected on a one-by-one basis by the IC tags. Namely, when handing over the product, the PC unique identifying information may be associated with the components. On the other hand, when the order is given at the website or by telephone, the sale may be confirmed in the same procedure when delivering the product.

Further, when giving the order, an available scheme is that the ordered product is managed by an order ID, and thereafter, i.e., after a fixed period, e.g., after assembling the product, or when handing over the personal computer, the PC unique identifying information may be generated. Then, when assembling the product or when handing over the personal computer, the PC unique identifying information is attached to the personal computer and is stored in the sales management DB.

### <Description of Whole System>

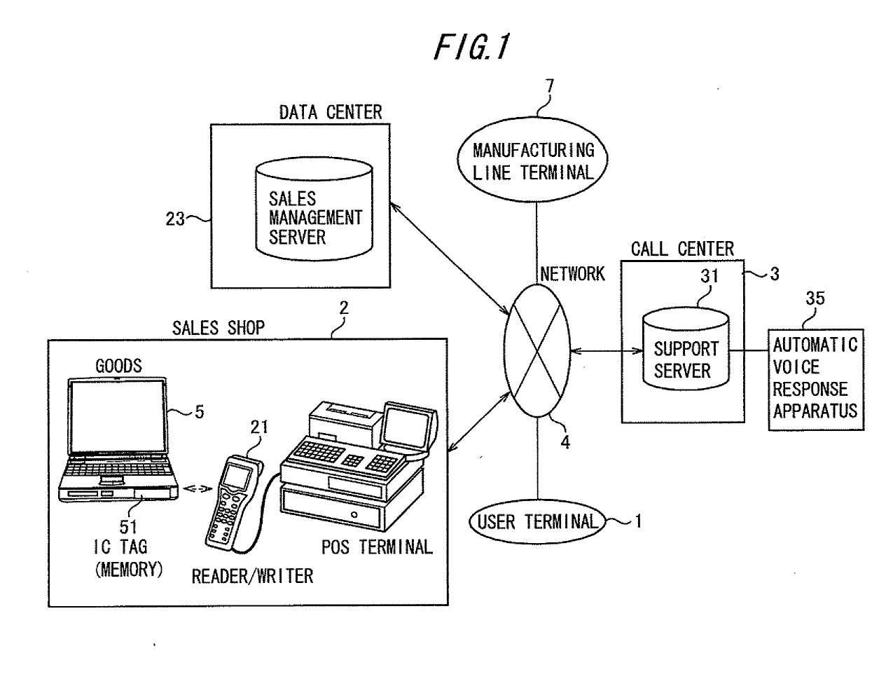

FIG. 1 is a conceptual diagram of this type of information system. The information system includes a user terminal 1 possessed by the user, a web server for providing a web site, a sales management server 23 that collects the information from the computer at a sales shop 2, and a support server 31 installed at a call center 3.

These terminal computers and servers are connected to each other in a communication-enabled status via a communication network 4. The support server 31 is communicable with both of the user terminal 1 and the sales management server 23, however, the user terminal 1 and the sales management server 23 normally do not, though communicable with each other, perform the communications with each other.

The communication network 4 can be exemplified as follows. For example, the communication network 4 is a wired network such as a telephone line, a LAN (Local Area Network) a cable TV/network, an xDSL (xDigital Subscriber Line), an ADSL (Asymmetrical Digital Subscriber Line) and an optical network or a wireless accessible network such as a wireless LAN and fixed wireless access (FWA). These communication networks are generally connected to the Internet.

Then, each of these terminals and servers includes, as known well, components normally incorporated into the personal computer, such as a CPU (Central Processing Unit) that executes a computer program, a memory stored with a computer program executed by the CPU and with data processed by the CPU, a network communication module defined as an interface with the communication network, and a monitor that displays a content of the execution of the program.

Note that there can reside multiplicities of the user terminals 1, the web servers of the web site, the computers of the sales shop 2 and the support servers 31 of the call center. For simplicity of the explanation, however, FIG. 1 shows the single equipment in each device category. Further, in the embodiment, the single sales management server 23 is provided on the network.

Further, what is designated by the numeral 7 in FIG. 1 is a manufacturing line terminal installed on a manufacturing line of the product. The manufacturing line terminal 7 performs the communications with the sales management server 23 via the communication network 4. The respective components configuring the present system will hereinafter be described.

### <User Terminal>

The user terminal 1 is communication equipment exemplified by the telephone and the personal computer. Further, the product possessed by the user is exemplified by the personal computer of which many users require the support service.

In the embodiment, the discussion starts with a case in which the user terminal 1 is the telephone. Hence, the user terminal 1 might be expressed as the telephone 1A. For receiving the support service, in terms of the necessity that the user provides the user identifying information to the support server 31, the telephone involves applying a telephone capable of outputting a tone signal by a dial operation. On the occasion of receiving the support service, the user previously has a user ID defined as user identifying information and the PC unique identifying information defined as the identifying information unique to the product.

The user ID is a code unique to the user, which is allocated to the user for the first time when the user first makes contact with the call center 3. The user ID is a number for managing individual information of the user. Then, the user ID is, when the user is registered, issued to the user from the support server. The registration of the user implies that the user who purchased the product notifies the maker that the user himself or herself is the purchaser, which involves containing items of individual information such as a user's contact address.

Further, the PC unique identifying information, which is a specified serial number (unique number), is a code unique to and assigned to the personal computer at a stage of manufacturing the personal computer 5, wherein the serial number and the code are each defined as the one and only number. The serial numbers are [manufacturing numbers] uniformly allocated to industrial goods (such as electric appliances, cameras and automobiles) that are mass-produced into the products.

In principle, none of the product having the same serial number exists in the same product class. From this principle, the serial number is used for a follow-up check by the maker if the product has inconvenience, for management in sales of secondhand goods and for checking a stolen article. Product information and component identifying information are associated with each other according to every serial number. The product information contains a name of the product, a name of the model, the serial number and, in addition, if the product is the personal computer, a utilized OS (Operating System) etc.

Moreover, the component identifying information is information (accept information) related to an order-accepted commercial product accepted from the user on the website or at the sale shop 2 as a component selected from within a component group (or option components) selectable when selling the personal computer 5 (or when accepting the order of the BTO-based personal computer 5). If, e.g., a TV tuner card is attached as an option to the personal computer, the component identifying information includes a name of the product, a name of the model and a serial number of the TV tuner card. Further, the component identifying information is parts information defined as assembly information with respect to the components (parts) building up the product, and is also information about individually sale-enabled components such as the CPU and the memory. This type of self-customized personal computer is called a BTO-based personal computer. Note that as compared with the BTO-based personal computer, a personal computer having an increased general-purpose by adapting the PC specification to a variety of customers is called a standard personal computer.

A so-called checksum system is adopted for the PC unique identifying information. Therefore, the PC unique identifying information is organized by a combination of a sequential number and a checksum of the last two digits. This scheme prevents the third party from accessing the call center 3 by freely using the PC unique identifying information.

<Sales Management Server>

Next, the sales management server will be described. The sales management server 23, which is installed at the web market or the sates shop 2, collects the information from the web server and the computer, and manages the collected information. Further, the sales management server 23 becomes an information source that provides the data and the services in response to requests given from other computers.

The computer at the sales shop 2 is a POS (Point of Sales) terminal having a reader/writer 21. The reader/writer 21 reads information of an IC tag 51 attached to the personal computer 5 when manufactured, and the readout information is stored in the POS terminal. Moreover, the sales management server 23 is notified of the readout information.

The POS terminal is one of terminals configuring the sales information management system. The POS terminal collects various categories of information in real time and aims at managing the commercial products and managing the sales at a single-item level. In the embodiment, the sales management server 23 is notified of the information inputted to the computer at the sales shop 2 via the network. Subsequently exemplified is a case in which after selling the product such as the personal computer 5, the sales management server 23 is utilized as the information source for performing the support service provided to the user related to the thus-sold product.

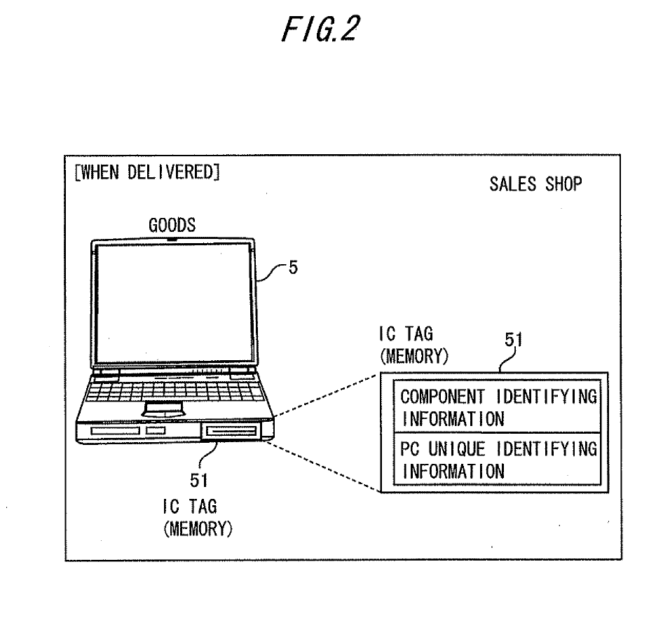

The IC tag 51 is stored with the PC unique identifying information as the unique-to-the-product identifying information stored when manufacturing the personal computer and with the model name of the personal computer. Further, the IC tag 51 is stored, when manufacturing the personal computer, with the component identifying information such as the product name, the model name and the serial number in order to manage the composition when selling one or more individually sale-enabled components (the components for fabricating the BTO-based personal computer such as the parts of the CPU etc and the option parts of the TV tuner card etc) of the personal computer 5 (see FIG. 2).

Then, these items of information stored in the IC tag 51 are read by the reader/writer 21 of the POS terminal when selling the personal computer 5 and stored in the storage device (which will hereinafter be referred to as the sales management DB: sales management database) of the sales management server 23 defined as sales storage means via the communication network 4.

The component identifying information can be read and inputted to the sales management DB by use of input means such as a keyboard other than the reader/writer 21. These input means can be said to be means that accept, when the personal computer 5 is sold, the input of the component identifying information of the component selected from the selectable component group when selling the product or giving the order of the product.

Furthermore, the sales management server 23 is, as already described, connected via the communication network 4 to the manufacturing line terminal 7 installed on the manufacturing line at the manufacturing factory of the personal computer 5 (see FIG. 1). Then, the acceptance information defined as the information about the order-accepted commercial product accepted from the user is transmitted to the manufacturing line terminal 7 from the sales management server 23. On the manufacturing line, the personal computer 5 is manufactured based on the acceptance information.

On the occasion of manufacturing the personal computers 5, the sales management server 23 generates the product identifying information in order to distinguish between the unique personal computer 5 including the options and the parts selected by the user and other sold personal computers 5.

The pieces of PC unique identifying information contain, e.g., the serial numbers organized by combinations of sequential numbers and the checksums of the last two digits, which are previously stored in a table provided in the sales management DB. Further, as the product identifying information, a number (which will hereinafter be referred to as a shop number) is assigned to every web site or the shop, and the serial number may be obtained by prefixing the shop number to the sequential number. The serial number for every shop can be issued by prefixing the shop number.

Furthermore, the PC unique identifying information may also be generated by acquiring an order date/time from the OS. Hence, the CPU of the sales management server 23 can be said to be means that generates the product identifying information.

Moreover, the sales management server 23 is programmed to prompt a worker on the manufacturing line to physically attach the product identifying information to the personal computer 5 that is put on the market. The physical attachment involves storing the product identifying information in the IC tag 51 attached to the personal computer 5, posting a seal printed with the product identifying information to a rear surface or a backside of the personal computer 5, or engraving the product identifying information in the rear surface or the backside thereof.

What is considered as a method of prompting the worker on the manufacturing line to attach the information is, e.g., a method of transmitting instruction data for prompting the worker to physically attach the PC unique identifying information to the manufacturing line terminal 7 via the communication network 4 from the network communication module (interface) and displaying the information on a display.

The transmission of the instruction data to the manufacturing line terminal 7 is executed based on an instruction of the CPU of the sales management server 23 as triggered by accepting the order. Hence, the CPU of the sales management server 23 can be said to be means that prompts the worker to attach the product identifying information to the product to be sold.

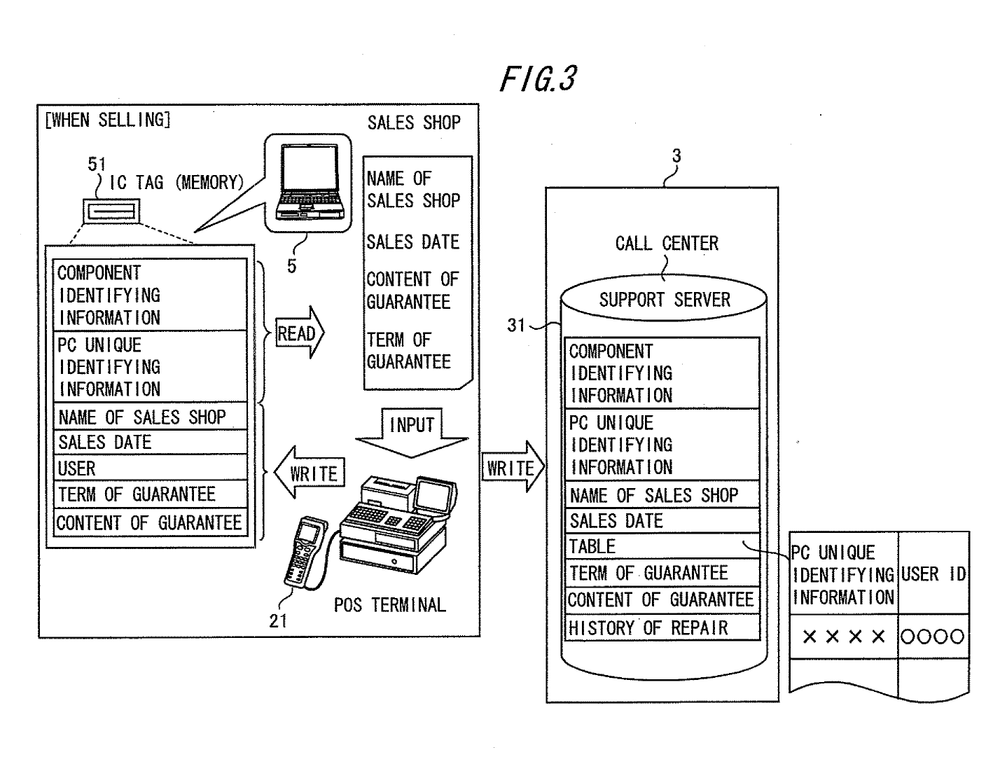

On the other hand, when selling the personal computer 5, a name of the sales shop, a sales date, a content of guarantee, a term of the guarantee, etc are inputted to the POS terminal on the shop side (see FIG. 3). These items of information are written also to the IC tag 51 by the reader/writer 21 when selling the personal computer 5.

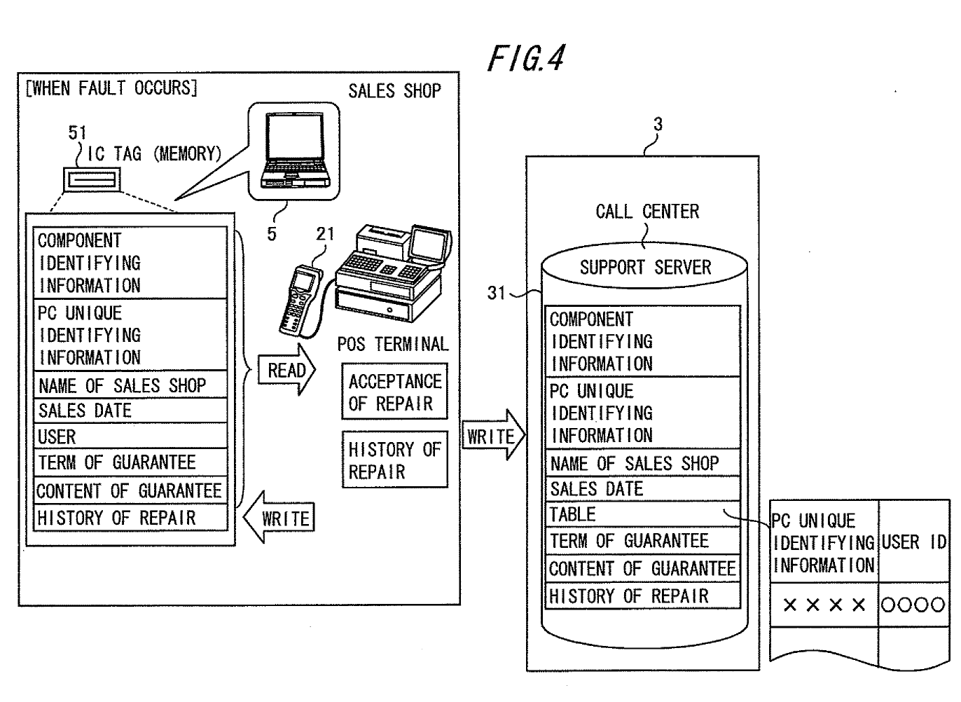

Note that if repaired, a history of this repair is inputted to the POS terminal and, when returned to the user, stored in the IC tag 51 (see FIG. 4).

Then, the information (which is also the information stored in the IC tag 51) related to the personal computer 5, which is inputted to the POS terminal, is transmitted through the sales management server 23 to the support server 31 via the communication network 4 when the support service about the personal computer 5 is provided to the user.

The information about the personal computer 5 contains at least the PC unique identifying information and the component identifying information, and both items of information are combined and thus stored in the sales management DB as the memory of the sales management server. The sales management DB is stored with the parts information of the personal computer 5 and can be therefore said to be configuration storage means of the personal computer 5.

Further, the sales management server 23 acquires a user ID together with the product identifying information of the personal computer 5 from the support server 31 via the communication network 4 by use of the CPU thereof. Hence, the CPU of the sales management server 23 is also means that acquires the user ID of the personal computer 5 together with the product identifying information of the personal computer 5 via the support server 31. The product identifying information and the user ID are stored in the sales management DB. Therefore, the sales management DB can be said to be means stored with the combination of the user ID of the personal computer 5 and the product identifying information of the personal computer 5 via the support server 31.

The information on the personal computer 5 that is stored in the sales management DB is, if the user requests the call center 3 to provide the support service, generated in, e.g., a list table and transmitted to support staff at the call center 3. In other words, after the call has arrived at the support server 31 at the call center from the telephone 1A serving as the user terminal and if a requirement for receiving the support service is satisfied, the support server 31 is provided with the information of the personal computer 5, which is stored in the sales management DB.

The sales management server 23, if there is a difference between the user ID already stored in the sales management DB in association with the product identifying information unique to the personal computer 5 which the support server 31 has notified of and the user ID of which the support server 31 notifies, reports this purport to the support server 31. When the support server 31 receives this report, the support staff in charge can make a psychological preparation beforehand about how the staff can deal with the user. Consequently the staff can afford to deal with the user.

Hence, the sales management server 23 can be said to be means which, if there is a difference between the user identifying information already stored in the user storage means in association with the product identifying information which the support server 31 has notified of and the user ID of which the support server notifies, reports this purport to the support server.

### <Support Server>

The support server 31 is a computer installed at the call center 3 and is operated by the support staff as work forces of the call center 3. The support staff always stands by at the call center and supports the user when the user inquires about a fault of the system. During a period till the support staff communicates with the user after the support server 31 has received the call from the telephone 1A, however, an automatic voice response apparatus 35 may automatically support.

The automatic voice response apparatus 35 is an apparatus using a computer for responding to the telephone, inputting and outputting the voice information, and performing an interactive operation. Further, the automatic voice response apparatus 35 distinguishes between the tone signals output from the telephone 1A and accepts necessary items of information. The necessary items of information are the user ID defined as the user identifying information and the PC unique identifying information.

When the user terminal 1 is operated by the user and when the user ID is inputted to the support server 31, the support server 31 determines whether the user is an authorized support target user or not. Then, the PC unique identifying information is inputted to the support server 31 from the user terminal 1, thereby enabling the support server 31 to acquire the various items of information related to the personal computer 5 that have been inputted to the sales management server via the communication network 4.

On such an occasion that the support server 31 acquires these items of information, as operations between the telephone 1A and the automatic voice response apparatus 35, the information is inputted to the automatic voice response apparatus 35 from the telephone 1A, and the voices previously recorded in the automatic voice response apparatus 35 are output to the telephone 1A. The telephone 1A accepts, based on the voice instructions output from the automatic voice response apparatus 35, the inputs of the necessary instructions from the user.

The input of the information to the automatic voice response apparatus 35 from the telephone 1A is realized in such a way that the automatic voice response apparatus 35 receives the tone signal output from the telephone 1A by the user's dial operation and recognizes the user's voice uttered from the telephone 1A. The output from the automatic voice response apparatus 35 is executed by combining the voices recorded beforehand in the automatic voice response apparatus 35 or by use of synthetic voices.

The content of the dial operation and the utterance of the user are recorded. The content to be recorded contains the user ID and the PC unique identifying information. Hence, the automatic voice response apparatus 35 included in the support server 31 can be said to be means which accepts the user ID and the product identifying information of the personal computer 5 as the service target product of the service desired to be provided to the user from the telephone 1A defined as the user terminal.

Moreover, these items of information are stored in the storage device (which will hereinafter be referred to as a user registration database: user registration DB) serving as user product storage means of the support server 31. The user registration DB can be therefore said to be user product storage means stored with the user ID and the product identifying information.

Further, the support server 31 is programmed so that the CPU of the support server 31 transmits and notifies the user ID and the PC unique identifying information stored in the user registration DB to the sales management server 23 via the communication network 4. Hence, the CPU can be said to be means which notifies the sales management server 23 of the user identifying information of the personal computer 5 together with the product identifying information of the personal computer 5.

Still further, the support server 31 is programmed so that the CPU thereof can receive the component identifying information of the parts and the option components included in the personal computer 5 identified by the product identifying information via the communication network 4 from the sales management server 23. Accordingly, the CPU of the support server 31 can be said to be means which receives from the sales management server 23 the component identifying information of the components included in the product identified by the product identifying information.

The component identifying information is organized into the list table and is thus output by the support server 31. List table generation data for generating the list table is transmitted to the support server 31 via the communication network 4 from the sales management server 23. Then, the support server 31 receives the list table generation data. The support server 31 generates, based on the list table generation data received by the support server 31, the list table of the component identifying information. Incidentally, a preferable scheme is that only the component identifying information may be displayed in this list table, however, all pieces of information about the personal computer 5 are displayed as the list table.

The information about the personal computer 5 contains, as described above, the accept information, the name of the sales shop, the sales date, the content of the guarantee, the term of the guarantee, the PC unique identifying information, the user ID, the user's telephone number and address and other items of individual information. The list table is associated with at least the PC unique identifying information and can be generated if the PC unique identifying information is known.

The list table containing the received component identifying information is output to an unillustrated monitor of the support server 31 or is printed by a printer. The support staff can browse through this list table that becomes a reference material when the user makes a request for providing the support service and is useful for providing the proper service. The monitor and the printer can be said to be means which display the component identifying information received from the sales management server 23.

Furthermore, the support server 31 provides, by use of the CPU thereof, a function of collating, when the user registration DB has already been stored with the user ID and the product identifying information accepted from the user, this accepted product identifying information. To be specific, the support server 31 is programmed to display on the monitor, e.g., the already-stored user ID and the accepted user ID so that the already-stored user ID can be collated with the accepted user ID in a user table format. Hence, the CPU can be said to be means which displays, when the accepted user identifying information and the product identifying information have already been stored in the user product storage means, the already-stored user identifying information and the accepted user identifying information so that these pieces of user identifying information can be collocated with the accepted product identifying information. Moreover, the support server 31 issues the user ID to the support target user. Issuance timing is when the user gives notification for the first time that the user wants to receive the support (which will hereinafter be referred to as support notification).

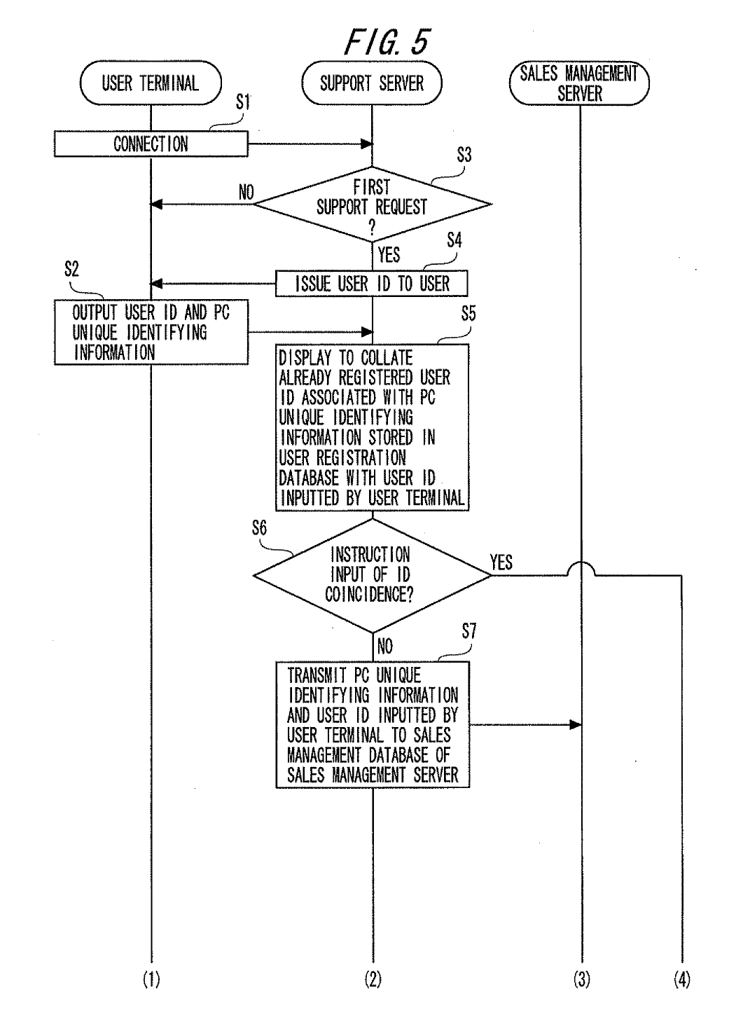

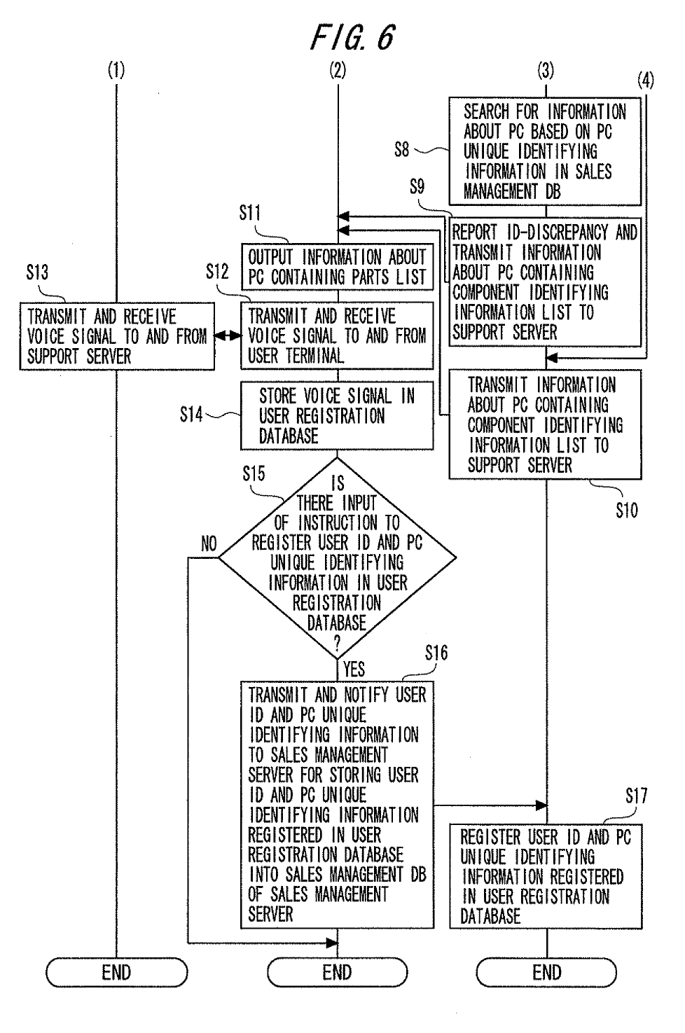

Next, a course till the support service is provided to the user will be explained with reference to a flowcharts in FIGS. 5 and 6. To begin with, the telephone 1A as the user terminal gets, upon undergoing the dial operation of the user, connected to the support server 31 at the call center 3 (S1).

Then, the user ID and the PC unique identifying information are converted into the tone signals, and the tone signals are output to the support server 31 from the telephone 1A by the dial operation of the user receiving the instruction of the automatic voice response apparatus 35 of the support server 31 (S2).

The automatic voice response apparatus 35 at the call center 3 converts the tone signals acquired from the telephone 1A into the user ID and the PC unique identifying information. Then, a scheme is that it is determined from the user ID and the PC unique identifying information whether the user is the support target user or not. The user may, however, verbally inform the operator of the user ID and the PC unique identifying information.

On the other hand, the user, even though authorized, in the case of giving the support notification for the first time, does not hold the user ID and is therefore disabled from inputting to the telephone. Hence, if a predetermined period of time elapses since the user ID was not inputted to the telephone, the automatic voice response apparatus 35 determines whether the user is a person who receives the support for the first time or it is a wrong number. Then, the automatic voice response apparatus 35 utters a voice showing a content to advise the telephone 1A as the user terminal to acquire the user ID or to check whether it is a wrong number or not.

In response to this utterance, the tone signal for informing that this is the first support is transmitted from the telephone 1A by the user's dial operation (S3). Then, the automatic voice response apparatus 35 speaks to the telephone 1A that the user ID is issued to the user who operates the telephone 1A. Subsequently, the support server 31 issues the user ID (S4). Accordingly, the telephone 1A receives the user ID. Note that the user ID may be transmitted by an e-mail to the user.

Further, if there is no answer from the telephone 1A even after a short time, the automatic voice response apparatus 35 automatically disconnects the telephone 1A.

After receiving the user ID, the processing proceeds to S2. In S2, as already described, the telephone 1A accepts the input from the user. Then, the telephone 1A converts the user ID and the PC unique identifying information into the tone signals and outputs the tone signals to the automatic voice response apparatus 35 of the support server 31.

As a result, the support server 31, when receiving these items of information via the automatic voice response apparatus 35, checks whether or not the received user ID and the received product identifying information have already been stored in the user registration DB. Then, when the user ID and the product identifying information are stored therein, the support server 31 displays the user ID and the product identifying information on the monitor so that the support staff can collate the accepted user ID with the already-stored user ID in association with the accepted product identifying information (S5).

Incidentally, as far as the user ID is issued for the first time in S4, when the user ID and the PC unique identifying information are output in S2, both of the user ID and the PC unique identifying information are stored as a pair in the user registration DB. At this time, even when the user ID and the PC unique identifying information are not again output, both are displayed for the collation in S5.

A result of whether the already-stored user ID and the accepted user ID are coincident with each other or not, corresponds to what the support staff seeing the content displayed on the monitor inputs the instruction to the support server 31. The support server 31 selects a next operation depending on whether both of the IDs are coincident with each other or not. Namely, if the support server 31 receives, from the support staff, the instruction input showing the coincidence between both of the IDs (S6), the sales management server 23 transmits the list table generation data to the support server 31 via the communication network 4 (S10).

Thereafter, the support server 31 receiving the list table generation data generates, based on the received data, the list table containing at least the component identifying information, and outputs the list table (S11).

Conversely, the support server 31, if none of the instruction input of the coincidence is received from the support staff (S6), transmits the PC unique identifying information and the user ID inputted by the telephone 1A to the sales management DB of the sales management server 23 (S7). If the user makes a mistake in the dial operation and if an unauthorized user inputs the user ID maliciously, the instruction input of the coincidence is not made by the support staff in S6.

In the discussion made so far, the result of whether the pair of the inputted user ID and PC unique identifying information is coincident with the pair of the already-stored user ID and PC unique identifying information or not, is confirmed from the input of the operator. The support server 31 may, however, make the collation about whether the pair of the already-stored user ID and PC unique identifying information is coincident with the pair of the accepted user ID and PC unique identifying information.

Then, the sales management server 23 searches for customer-by-customer information in the sales management DB on the basis of the PC unique identifying information (S8). Herein, a premise is that the support server 31 does not receive the instruction input of the coincidence between the IDs from the support staff. Hence, the sales management server 23 transmits, to the support server 31, the list table generation data containing the data for enabling the ID non-coincidence report to be displayed (S9).

The support server 31 generates, based on the received list table generation data, the list table containing at least the component identifying information and outputs the generated list table (S11). The support staff can browse through the list table output from the support server 31.

The list table is preferably organized to output other items of information related to the personal computer 5 as well as to output the component identifying information. A larger quantity of information enables the support staff to comprehend more clearly the reason why the user IDs are not coincident and enables the user to be provided with more elaborate support service, thereby smoothly facilitating the communications between the support staff and the user.

Then, the support server 31 receives the instruction input of the support staff, which serves to attain the speech-enabled status between the caller user and the support staff. Then, the automatic voice response apparatus 35 comes to the speech-enabled status with the telephone 1A. Namely, the user terminal 1 and the support server 31 come to the status in which the voice signals can be transmitted to and received from each other (S12, S13).

Note that the “support” connoted herein is not limited to providing the usage of the personal computer 5 and the support service to the user if a trouble occurs. The “support” embraces providing the user with such an item of information that the user is enable to receive the service.

Upon finishing the phone conversation, i.e., upon termination of transmitting and receiving the voice signals between the telephone 1A and the support server 31, the processes related to the telephone 1A defined as the user terminal are finished. On the other hand, the support server 31 advances to S14.

In S14, the voice signals communicated between the telephone 1A and the support server 31, i.e., the contents of the communications, are stored in the user registration DB of the support server 31 (S14).

Thereafter, the support staff judges, from the communications between the user and the support staff in S12 and S13, whether the PC unique identifying information and the user ID are registered in the user registration DB or not. Then, the support staff inputs the instruction input to the support server 31 (S15).

A reason why this judgment is required is that unless the user ID already stored in the user registration DB is coincident with the user ID accepted by the telephone 1A (S6), the user can not receive the support. Hence, as for the user who acquired the user ID, it is required that the user ID and the PC unique identifying information of the personal computer 5 be registered in the user registration DB in a way that associates these items of information with each other.

When the support staff inputs the instruction input having a content that is a negative determination in S15 to the support server 31, the processes of the support server 31 come to an end. Then, when the support staff inputs the instruction input having a content that is an affirmative determination to the support server 31, the support server 31 advances to S16.

The case of negating in S15 is the case in which the user ID and the PC unique identifying information have already been stored in the way of being associated with each other in the user registration DB. This is the case where the support staff judges in S6 that the already-stored user ID in the user registration DB is coincident with the user ID accepted by the telephone 1A and the support server 31 receives the instruction input showing this purport, which has been inputted by the support staff. The user ID and the PC unique identifying information have already been stored in the user registration DB, and hence there is no necessity of again storing these items of information.

Whereas if affirmative in S15, this is the case in which the support staff judges in S6 that the already-stored user ID in the user registration DB is not coincident with the user ID accepted by the telephone 1A and the support server 31 receives the instruction input showing this purport, which has been inputted by the support staff.

The affirmative case in S15 is a case where, e.g., a normal transfer is conducted, and the owner at the present is exchanged with a different owner when sold. In such a case, if within a term of guarantee capable of providing the support, continuance of the support may be permitted. For example, if a content of being able to receive the support service even after the transfer, i.e., a provision of continuing the guarantee is specified in a support agreement, the contents of the registrations in the user registration DB and in the sales management database DB are requested to be reexamined based on the items of the registration related to the present owner.

Note that the registrations in the user registration DB and in the sales management database DB may be, as a matter of course, executed each time, however, an available scheme is that the items of information accepted till the end of a series of processes are retained as logs and may also be thereafter processed batchwise by a process of executing a batch process.

In S16, the user ID registered in the user registration DB and the PC unique identifying information associated with the user ID are transmitted to the sales management server 23. The user ID and the PC unique identifying information are thereby stored in the sales management database DB of the sales management server 23. After this storage, the processes of the support server 31 are terminated.

The sales management server 23 is notified of the user ID and the PC unique identifying information in S16 registers, in the sales management database DB, the user ID and the PC unique identifying information, which have been registered in the user registration DB, and the processes of the sales management server 23 come to an end (S17).

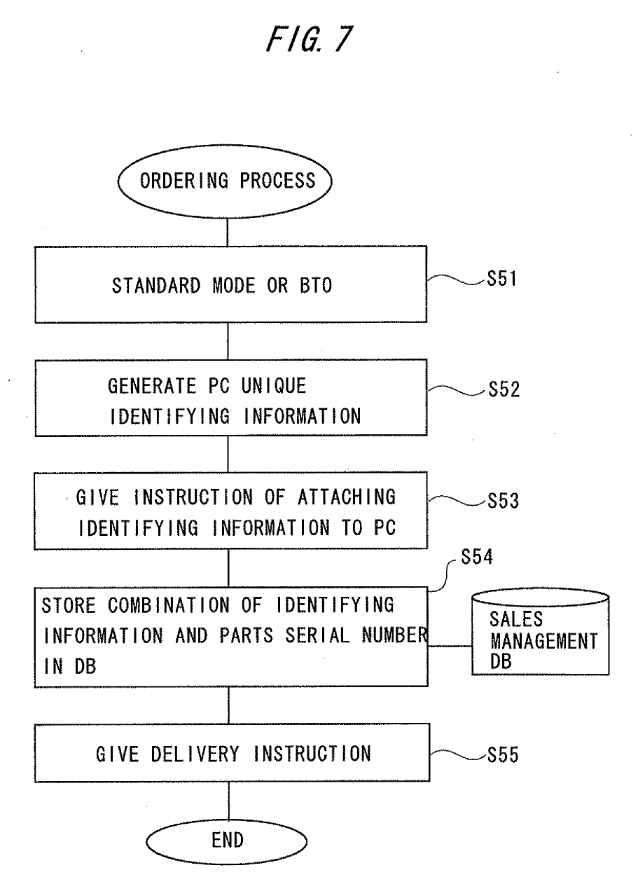

Referring next to FIG. 7, the subsequent processes in the case of receiving the order of the personal computer at the web market or at the sales shop, will be explained.

When the operator at the web market and a shop clerk (which will hereinafter simply be referred to as the clerk etc) at the sales shop, the POS terminal receives, from the clerk etc, an instruction input showing whether the order-accepted personal computer is the standard personal computer or the BTO-based personal computer (S51). The instruction input is transmitted as order data to the sales management server 23 via the communication network 4. The order data is data containing a content of the order given from the customer related to the order-accepted commercial product.

Upon receiving the order data through the instruction input in S51, the sales management server 23 generates the PC unique identifying information (S52).

After generating the PC unique identifying information, the sales management server 23 transmits the order data together with the PC unique identifying information via the communication network 4 to the manufacturing line terminal 7 installed on the manufacturing line at the personal computer manufacturing factory.

The order data contains, as already described, at least the component identifying information such as the product names, the model names and the serial numbers of the individually sale-enabled components in order to manage on-sale configurations of one or more individually sale-enabled components of the personal computer 5.

Next, the sales management server 23 transmits instruction data for prompting the manufacturing line terminal 7 to physically attach the PC unique identifying information to the personal computer 5 to the manufacturing line terminal 7 on the manufacturing line via the communication network 4 (S53). The physical attachment represents, as already explained, storing the product identifying information in the IC tag 51 attached to the personal computer 5 and posting the seal printed with the product identifying information to the rear surface or the backside of the personal computer 5 or engraving the product identifying information therein.

Thereafter, the POS terminal stores and saves the PC unique identifying information and the component identifying information in the sales management database of the sales management server 23 (S54).

Further, the sales management server 23, along with this operation, instructs the manufacturing line terminal 7 to determine a time limit for delivering the product, i.e., determine a date of shipping (S55), and a series of processes are finished.

### <Operation/Effect>

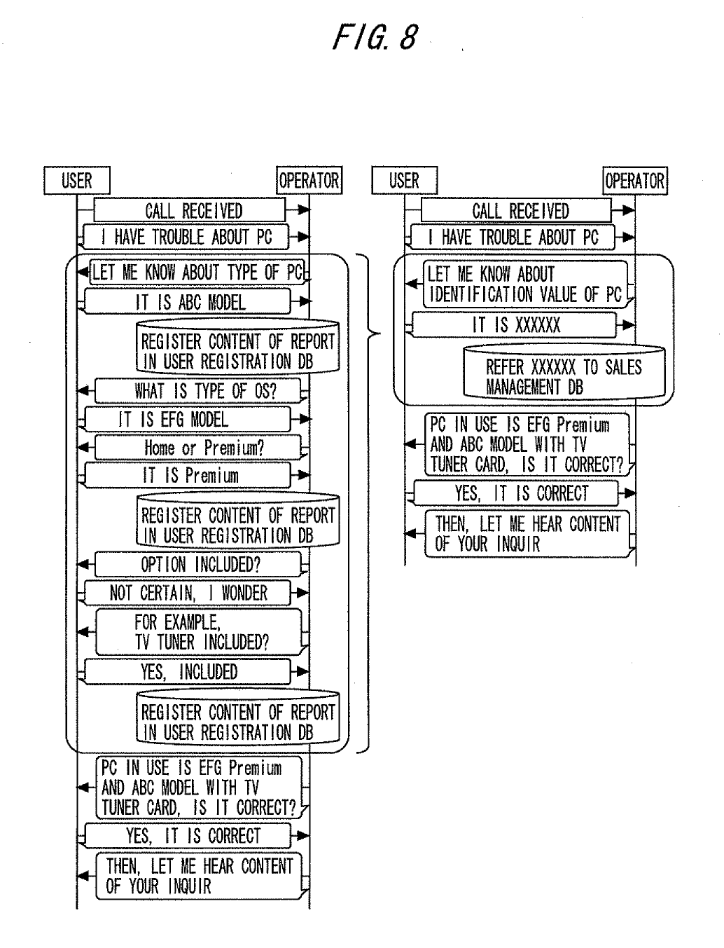

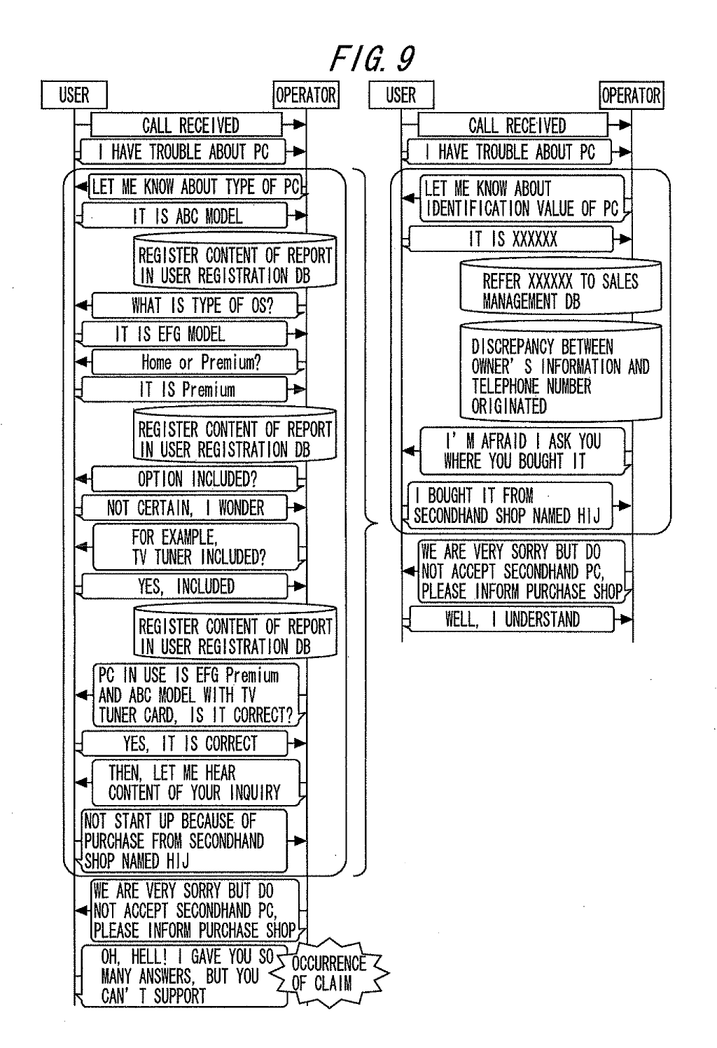

Next, an operation and an effect of the present system will be described with reference to FIGS. 8 through 10. FIGS. 8 and 9 illustrate how the user and the support staff (operator) exchange their queries and answers in comparison between the conventional system and the present system.

Further, FIGS. 8 and 9 show the contents concerning S12 and S13 in the flowcharts of FIGS. 5 and 6 for illustrating the course of providing the support service to the user, and exemplify the cases different from each other. FIG. 8 exemplifies the case in which the time required for the support staff to grasp the conditions of the personal computer owned by the user is remarkably reduced.

The flowchart on the left side in FIG. 8 illustrates how the user and the support staff exchange their queries and answers in the conventional system, while the flowchart on the right side illustrates how both of the user and the support staff exchange their queries and answers in the case to which the present system is applied.

The conventional system entails having eighteen (18) conversations counted at the arrival of the call from the (first) query of the user down to the (final) answer of the support staff, while the present system involves, it is understood, mere eight (8) conversations. This is derived from a point that the support server includes the means which displays, when the accepted user ID and the PC unique identifying information have already been stored in the user registration DB, the already-stored user ID and the accepted user ID in association with the accepted PC unique identifying information in order to collate these user IDs with each other, and consequently the support staff has already comprehended the displayed items and therefore has no necessity for making the known questions to the users. Hence, a period of time till the user obtains the answer to the user's query from the support staff can be reduced. It can be therefore expected that a degree of satisfaction of the customer is improved.

FIG. 9 shows a case where the user who is not the owner at the selling time makes a request for the support, and exemplifies a case in which a claim gets hard to occur because of notifying the user in a short time that the user is unable to receive the support. The conventional system has undergone a considerable number (18) of conversations counted from the arrival of the call till the support staff answered to the query of the user, and nevertheless eventually the claim occurs because of being unable to receive the support.

By contrast, the present system finishes the (answer-to-query) operation with mere ten (10) conversations from the reception of the call till the user understands that the user is a non-support target user, and consequently the claim is hard to arise. Thus, it is known through the mere steps as compared with the conventional system that the owner of the personal computer has changed, and this is because the sales management DB of the sales management server 23 is stored with the pair of the product identifying information defined as the PC unique identifying information and the component identifying information.

Further, the reason why the mere steps are sufficient for the support staff to answer to the query of the user and why the claim is hard to occur in the case of explaining that the user is the non-support target user, lies in such a point that the present system provides an item-to-item association drawing system for grasping how the component identifying information is associated with the product identifying information as the associative items of information once the PC unique identifying information is known. Owing to this systematic scheme, the support server 31 is easy to, when receiving the request for the support, specify the parts and the option components of the personal computer owned by the customer and has no necessity for inquiring the customer about these items of information each time.

Moreover, the contents of the report given from the user can be narrowed down to only the unique identifying information of the already-sold personal computer 5, then it is therefore feasible to prevent the user from mistakenly registering any one item of information, the model name or the manufacturing number, as the number for receiving the support as hitherto done, and hence plural sets of the same PC information do not exist among the users. Consequently, the information does not get intricate, whereby discrepancies are hard to occur with respect to the users

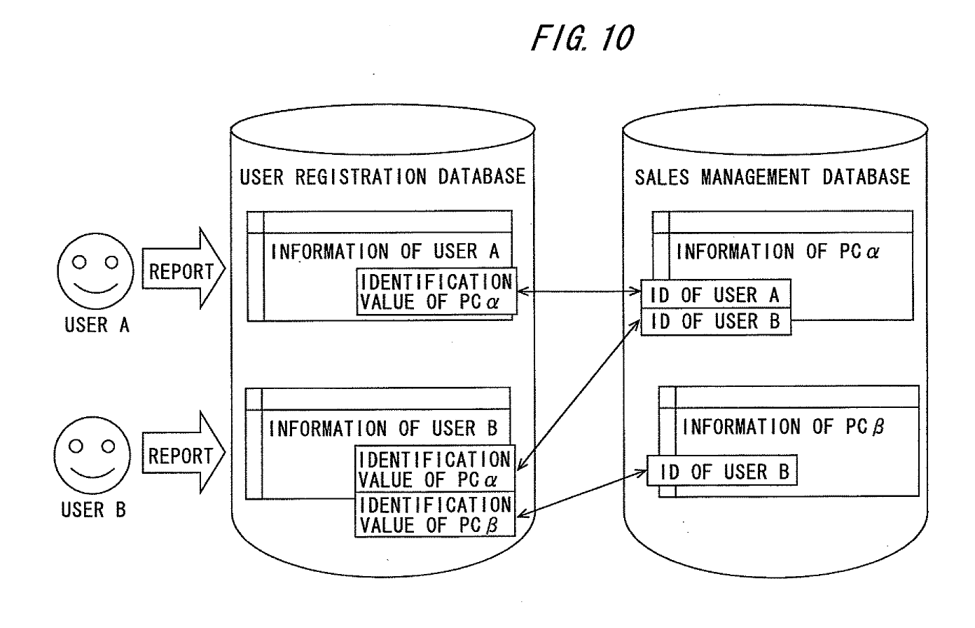

FIG. 10 is also an explanatory diagram showing the contents of the user registration DB of the support server 31 and the sales management DB of the sales management server 23.

In the user registration DB, a user A holds the PC unique identifying information (which is an identification value in FIG. 10) of a personal computer α as the information of the user A reporting the user registration, and a user B holds pieces of PC unique identifying information of both of personal computers α and β as the information of the user B.

Further, in the sales management DB, the personal computer α is registered with the user IDs of both of the users A and B as the information of the sold personal computer α, and the personal computer β is registered with the user ID of the user B as the information of the personal computer β.

Thus, not only the user registration DB but also the sales management DB are stored and saved with the user IDs, whereby the support providing side can promptly grasp, if the support server 31 receives the report that a plurality of persons owns the same personal computer, the discrepancy between the present owner and the owner when sold.

The case of grasping that the plurality of persons owns the same personal computer (the case showing the plurality of declarers) includes, as already described, the case in which the owner changes due to the formal transfer of the personal computer, the case where the owner changes because of trading the secondhand personal computer and a case where the personal computer is shared for use among or between family members.

In such a case, the support service might be requested by a person different from the person determined to be the normal declarer at the present, however, if the support is rejected based on a grounding that the declarer is simply different as hitherto done, a trouble might arise. It is, however, considered that if the personal computer is normally transferred and if within the term of the guarantee for providing the support, there is no problem even when providing the support.

Such being the case, if the support staff judges that the personal computer is utilized based on the warrantable right, there can be settled an agreement that different declarers are registered for a plurality of declarations saying the possession of the same personal computer.

Accordingly, in this case, as for the plurality of declarations saying the possession of the same personal computer, the support can be provided without being limited to the owner when sold.

Moreover, the support server 31 can provide the user terminal of the present owner of the personal computer 5 with the information corresponding to a follow-up history of the repair of the personal computer 5, deterioration of the components and a degree of abrasion of the personal computer 5.

Note that the embodiment discusses above has exemplified the case of showing the single sales management server 23, however, a plurality of sales management servers may also be installed for backup. Further, a plurality of sales management servers sharing the processes with each other may also be provided.

### <Readable-By-Computer Recording Medium>

A program for making a computer, other machines and devices (which will hereinafter be referred to as the computer etc) realize any one of the functions can be recorded on a recording medium readable by the computer etc. Then, the computer etc is made to read and execute the program on this recording medium, whereby the function thereof can be provided.

Herein, the recording medium readable by the computer etc connotes a recording medium capable of storing information such as data and programs electrically, magnetically, optically, mechanically or by chemical action, which can be read from the computer etc.

Among these recording mediums, for example, a flexible disc, a magneto-optic disc, a CD-ROM, a CD-R/W, a DVD, a DAT, an 8 mm tape, a memory card, etc are given as those removable from the computer.

Further, a hard disc, a ROM (Read-Only Memory), etc are given as the recording mediums fixed within the computer etc.

When the user terminal is the personal computer, a difference from the case of the telephone is that the call center 3 has no necessity for including the automatic voice response apparatus 35 because of the personal computer outputting none of the tone signal and that the user terminal and the support server perform the communications using the character data. Hence, other configurations are the same as in the case of the user terminal being the telephone, and their descriptions are omitted.

<Others>

The disclosures of Japanese patent application No. JP2007-272669 filed on Oct. 19, 2007 including the specification, drawings and abstract are incorporated herein by reference.

What is claimed is:

1. An information system comprising:
a sales management server managing an on-sale configuration of a product including one or more individually sale-enabled components; and
a support server providing an after-sale service to a user of the product,
said sales management server including:
a unit accepting an input of component identifying information of the component selected from within a selectable component group for the product when the product is sold;
a unit generating product identifying information for distinguishing between the sold product including the selected component and another sold product;
a configuration storage unit stored with a combination of the product identifying information generated for the product and the component identifying information of the component included in the product;
a unit prompting attachment of the product identifying information to the product to be sold;
a unit acquiring user identifying information of the product together with the product identifying information of the product via said support server; and
a sales user storage unit stored with a combination of the product identifying information and the user identifying information of the product,
said support server including:
a unit accepting, when providing the user of the product with the service, the user identifying information of the user and the product identifying information of the product becoming a service target product of a service with which the user desires to be provided;
a user product storage unit stored with the user identifying information and the product identifying information;
a unit notifying said sales management server of the product identifying information together with the accepted user identifying information;
a unit receiving, from said sales management server, the component identifying information of the component included in the product identified by the product identifying information; and
a first displaying unit displaying the received component identifying information.

2. The information system according to claim 1, wherein said support server further includes a second displaying unit displaying, when said user product storage unit has already been stored with the accepted user identifying information and the product identifying information, the already-stored user identifying information and the accepted user identifying information in a way that enables these pieces of user identifying information to be collated in association with the accepted product identifying information.

3. The information system according to claim 2, wherein said sales management server further includes a unit notifying, when said sales user storage unit has already been stored with the user identifying information in association with the product identifying information of which said support server notifies and when the stored user identifying information is different from the user identifying information of which said support server notifies, said support server of this purport.

4. A product information management method of managing information on a product, executed by an information system comprising: a sales management server managing an on-sale configuration of a product including one or more individually sale-enabled components; and a support server providing an after-sale service to a user of the product,
said sales management server executing:
a step of accepting an input of component identifying information of the component selected from within a selectable component group for the product when the product is sold;
a configuration storing step of generating product identifying information for distinguishing between the sold product including the selected component and another sold product;
a sales user storing step of storing a combination of the product identifying information generated for the product and the component identifying information of the component included in the product;
a step of prompting attachment of the product identifying information to the product to be sold;
a step of acquiring user identifying information of the product together with the product identifying information of the product via said support server; and
a user product storing step of storing a combination of the product identifying information and the user identifying information of the product,
said support server executing:
a step of accepting, when providing the user of the product with the service, the user identifying information of the user and the product identifying information of the product becoming a service target product of a service with which the user desires to be provided;
a step of storing the user identifying information and the product identifying information;
a step of notifying said sales management server of the product identifying information together with the accepted user identifying information;
a step of receiving, from said sales management server, the component identifying information of the component included in the product identified by the product identifying information; and
a step of displaying the received component identifying information.

5. A computer readable medium stored with a program making a computer linking up with a support server providing a service after selling a product to a user, execute:
a step of accepting an input of component identifying information of the component selected from within a selectable component group for the product when the product is sold;
a step of generating product identifying information for distinguishing between the sold product including the selected component and another sold product;
a configuration storing step of storing a combination of the product identifying information generated for the product and the component identifying information of the component included in the product;
a step of prompting attachment of the product identifying information to the product to be sold;
a step of acquiring user identifying information of the product together with the product identifying information of the product via said support server; and
a sales user storing step of storing a combination of the product identifying information and the user identifying information of the product.
